(19) United States
(12) Patent Application Publication
(10) Pub. No.: US 2023/0137719 A1
(43) Pub. Date: May 4, 2023

(54) APPARATUS, SYSTEM, AND METHOD OF SWITCHING A WIRELESS COMMUNICATION CHANNEL

(71) Applicant: INTEL CORPORATION, SANTA CLARA, CA (US)

(72) Inventors: Yaron Klein, Rosh Haayin (IL); Inbar West, Ein Shemer (IL); Drory Shohat, Kfar Saba (IL); Amihud Rothmann, HAIFA (IL)

(73) Assignee: INTEL CORPORATION, SANTA CLARA, CA (US)

(21) Appl. No.: 18/090,256

(22) Filed: Dec. 28, 2022

Related U.S. Application Data
(60) Provisional application No. 63/323,963, filed on Mar. 25, 2022.

(51) Int. Cl. H04W 72/02; H04W 24/10; H04W 72/52

(52) U.S. Cl. CPC H04W 72/02; H04W 24/10; H04W 72/52

(57) ABSTRACT

For example, an Access Point (AP) may be configured to transmit measurement requests to a plurality of wireless communication stations (STAs) in a Basic Service Set (BSS) of the AP; to process measurement reports from the plurality of STAs in the BSS, wherein a measurement report from a STA includes reported measurements of the STA with respect to one or more wireless communication channels; to determine a selected wireless communication channel for the BSS based on the measurement reports from the plurality of STAs in the BSS; and to trigger a channel switch to switch an operational channel of the BSS to the selected wireless communication channel.

### CROSS REFERENCE

This application claims the benefit of and priority from U.S. Provisional Patent Application No. 63/323,963 entitled “CLIENT DRIVEN DYNAMIC FREQUENCY SELECTION”, filed Mar. 25, 2022, the entire disclosure of which is incorporated herein by reference.

### TECHNICAL FIELD

Aspects described herein generally relate to switching a wireless communication channel.

### BACKGROUND

Devices in a wireless communication system may be configured to communicate according to communication protocols, which may utilize one or more wireless communication channels for communication between a first device, e.g., an Access Point (AP), and a second device, e.g., a non-AP wireless communication station.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of communications between an Access Point (AP) and client wireless communication Stations (STAs) according to a channel selection mechanism, in accordance with some demonstrative aspects.

FIG. 3 is a schematic illustration of a measurement report field format, which may be implemented in accordance with some demonstrative aspects.

FIG. 4 is a schematic flow-chart illustration of a method of switching a wireless communication channel, in accordance with some demonstrative aspects.

FIG. 5 is a schematic flow-chart illustration of a method of switching a wireless communication channel, in accordance with some demonstrative aspects.

FIG. 6 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band. Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

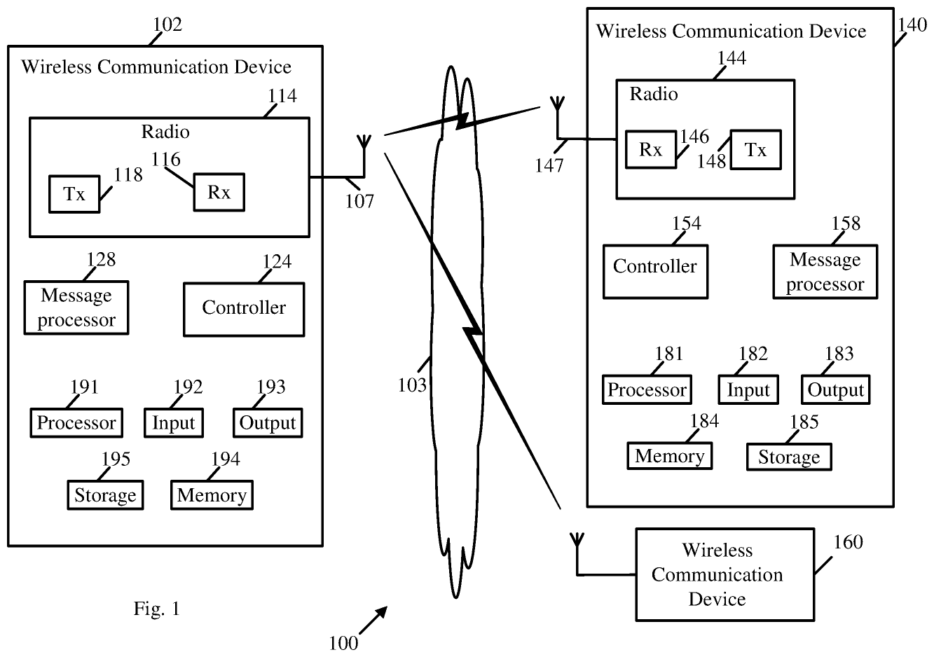

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a Smartphone, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a video source, an audio source, a video sink, an audio sink, a stereo tuner, a broadcast radio receiver, a digital audio player, a speaker, an audio receiver, an audio amplifier, a gaming device, a data source, a data sink, a media player, a television, a music player, a smart device such as, for example, lamps, climate control, car components, household components, appliances, and the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an OS of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, a cellular channel, an RF channel, a Wi-Fi channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, one or more channels in a 2.4 GHz wireless communication frequency band, one or more channels in a 5 GHz wireless communication frequency band, and/or one or more channels in a 6 GHz wireless communication frequency band. For example, WM 103 may additionally or alternatively include one or more channels in an mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include at least one radio 114, and/or device 140 may include at least one radio 144.

In some demonstrative aspects, radio 114 and/or radio 144 may include one or more wireless receivers (Rx) including circuitry and/or logic to receive wireless communication signals, RF signals, frames, blocks, transmission streams, packets, messages, data items, and/or data. For example, radio 114 may include at least one receiver 116, and/or radio 144 may include at least one receiver 146.

In some demonstrative aspects, radio 114 and/or radio 144 may include one or more wireless transmitters (Tx) including circuitry and/or logic to transmit wireless communication signals, RF signals, frames, blocks, transmission streams, packets, messages, data items, and/or data. For example, radio 114 may include at least one transmitter 118, and/or radio 144 may include at least one transmitter 148.

In some demonstrative aspects, radio 114 and/or radio 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radio 114 and/or radio 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, an mmWave band, and/or any other band, for example, a 5G band, an S1G band, and/or any other band.

In some demonstrative aspects, radios 114 and/or 144 may include, or may be associated with one or more antennas.

In some demonstrative aspects, device 102 may include one or more, e.g., a single antenna or a plurality of, antennas 107, and/or device 140 may include on or more, e.g., a single antenna or a plurality of, antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. Antennas 107 and/or 147 may include, for example, antennas suitable for directional communication, e.g., using beamforming techniques. For example, antennas 107 and/or 147 may include a single antenna, a plurality of antennas, a phased array antenna, a multiple element antenna, a set of switched beam antennas, and/or the like. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, antennas 107 and/or antennas 147 may be connected to, and/or associated with, one or more Radio Frequency (RF) chains.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of radio 114. For example, the chip or SoC may include one or more elements of controller 124, one or more elements of message processor 128, and/or one or more elements of radio 114. In one example, controller 124, message processor 128, and radio 114 may be implemented as part of the chip or SoC.

In other aspects, controller 124, message processor 128 and/or radio 114 may be implemented by one or more additional or alternative elements of device 102.

In some demonstrative aspects, at least part of the functionality of controller 154 and/or message processor 158 may be implemented by an integrated circuit, for example, a chip, e.g., a System on Chip (SoC). In one example, the chip or SoC may be configured to perform one or more functionalities of radio 144. For example, the chip or SoC may include one or more elements of controller 154, one or more elements of message processor 158, and/or one or more elements of radio 144. In one example, controller 154, message processor 158, and radio 144 may be implemented as part of the chip or SoC.

In other aspects, controller 154, message processor 158 and/or radio 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In other aspects, devices 102, 140 and/or 160 may include, operate as, perform the role of, and/or perform one or more functionalities of, any other wireless device and/or station, e.g., a WLAN STA, a Wi-Fi STA, and the like.

In some demonstrative aspects, device 102, device 140, and/or device 160 may be configured operate as, perform the role of, and/or perform one or more functionalities of, an Access Point (AP).

In some demonstrative aspects, device 102, device 140, and/or device 160 may be configured to operate as, perform the role of, and/or perform one or more functionalities of, a non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains a station (STA), e.g., one STA, and provides access to distribution services, via the wireless medium (WM) for associated STAs. The AP may perform any other additional or alternative functionality.

In one example, a non-AP STA may include a STA that is not contained within an AP. The non-AP STA may perform any other additional or alternative functionality.

In some demonstrative aspects, devices 102, 140 and/or 160 may be configured to operate in accordance with one or more Specifications, for example, including one or more IEEE 802.11 Specifications, e.g., an IEEE 802.11-2020 Specification and/or any other specification and/or protocol.

In some demonstrative aspects, device 102 may include, operate as, perform a role of, and/or perform the functionality of, an AP STA.

In some demonstrative aspects, device 140, and/or device 160 may include, operate as, perform a role of, and/or perform the functionality of, one or more non-AP STAs. For example, device 140 may include, operate as, perform a role of, and/or perform the functionality of, at least one non-AP STA, and/or device 160 may include, operate as, perform a role of, and/or perform the functionality of, at least one non-AP STA.

In some demonstrative aspects, device 102, device 140, and/or device 160 may be configured to implement one or more operations of a channel selection mechanism, which may be configured to provide a technical solution to support an AP, e.g., an AP implemented by device 102, in selection of a wireless communication channel, e.g., as described below.

In some demonstrative aspects, the channel selection mechanism may be configured to provide a technical solution to support improved performance and/or efficiency, e.g., as described below.

For example, some wireless networks, e.g., home wireless networks may suffer from low signal strength. For example, “noise” in a Wi-Fi network may be more or less “fixed” and, accordingly, a Received Signal Strength Indicator (RSSI) may be a key parameter for wireless network performance. For example, in some use cases, scenarios, deployments, and/or implementations, a low signal to noise ratio may cause low performance and/or connectivity issues.

For example, APs may be configured select the best wireless communication channel, e.g., to provide improved performance.

For example, an AP may be configured to use a Dynamic Frequency Selection (DFS) mechanism, for example, to automatically switch the AP to a less congested channel.

In some demonstrative aspects, for example, in some use cases, scenarios, and/or implementations, there may be a need to address one or more technical issues, for example, when configuring an AP to select a wireless communication channel for communication in a wireless network.

In some demonstrative aspects, for example, in some use cases, scenarios, and/or implementations, there may be one or more technical issues in implementing an AP, which is configured to select the best wireless communication channel to work on from AP's perspective and/or location, for example, without taking in consideration locations of client STAs.

In some demonstrative aspects, for example, in some use cases, scenarios, and/or implementations, a client STA may experience a noise “profile”, which may be different from a noise “profile” experienced by the AP.

For example, the noise around a client STA may be affected by obstacles, interferences and/or activities at a location of the STA, which may be different from obstacles, interferences and/or activities at the location of the AP.

In one example, client STAs may be configured to scan and select less congested channels on the AP side. However, such an implementation does not take into consideration the STA side.

In some demonstrative aspects, device 102, device 140, and/or device 160 may be configured to implement one or more operations of a channel selection mechanism, which may be configured to provide a technical solution to support an AP, e.g., an AP implemented by device 102, in selection of a wireless communication channel, for example, based on information received from one or more client STAs, e.g., as described below.

In some demonstrative aspects, the channel selection mechanism may be configured to provide a technical solution to coordinate a smarter and/or more adaptive selection of a wireless communication channel, e.g., as described below.

In some demonstrative aspects, the channel selection mechanism may be configured to provide a technical solution to support a collaborative channel selection, which may be based, for example, on a collaboration between an AP and one or more client STAs of the AP, e.g., as described below.

In some demonstrative aspects, the collaborative channel selection may be based, for example, on information measured at the AP, and on information provided by one or more client STAs, e.g., as described below.

In some demonstrative aspects, the channel selection mechanism may be configured to provide a technical solution to support channel selection at an AP, for example, based on dedicated client measurements of one or more client STAs, e.g., laptops and/or other types of mobile devices, in a wireless network controlled by the AP, e.g., as described below.

In some demonstrative aspects, the channel selection mechanism may be configured to utilize a Wi Fi ability of the client STAs to scan their conditions and convey that information back to the AP, for example, in order to negotiate a channel, e.g., the best channel, for the entire network controlled by the AP.

In some demonstrative aspects, the channel selection mechanism may be configured to provide a technical solution to support the AP in determining the preferred channel for the wireless network controlled by the AP, for example, by “negotiating” between preferences of the client STAs in the wireless network controlled by the AP, e.g., as described below.

In some demonstrative aspects, an AP, e.g., the AP implemented by device 102, may be configured to implement a channel selection mechanism, which may be configured to determine at the AP the preferred channel for the wireless network controlled by the AP, for example, based on information from one or more client STAs in the wireless network controlled by the AP, e.g., as described below.

In some demonstrative aspects, the channel selection mechanism may be configured to determine at the AP the preferred channel for the wireless network controlled by the AP, for example, based on measurement-based information from one or more client STAs in the wireless network controlled by the AP, e.g., as described below.

In some demonstrative aspects, the measurement-based information from a client STA may include information, which is based on measurements performed by the client STA, e.g., as described below.

In some demonstrative aspects, the channel selection mechanism may be configured to determine at the AP the preferred channel for the wireless network controlled by the AP, for example, based on channel load information from one or more client STAs in the wireless network controlled by the AP, e.g., as described below.

In some demonstrative aspects, the channel load information from a client STA may include, for example, a channel load value, which is based on a channel load measured by the client STA, e.g., as described below.

In some demonstrative aspects, the channel selection mechanism may be configured to determine at the AP the preferred channel for the wireless network controlled by the AP, for example, based on any other additional or alternative information from one or more client STAs in the wireless network controlled by the AP. For example, the preferred channel for the wireless network controlled by the AP may be determined, for example, based on noise histogram information and/or STA statistic information from one or more client STAs in the wireless network controlled by the AP.

In some demonstrative aspects, the channel selection mechanism may be configured to provide a technical solution to support adaptive channel selection, for example, smart adaptive channel selection, for example, using the information from the client STAs in the wireless network controlled by the AP, e.g., as described below.

In some demonstrative aspects, the channel selection mechanism may be configured to provide a technical solution to support the AP in a better channel switch for the network, for example, by taking into consideration the information from the client STAs, e.g., as described below.

In some demonstrative aspects, the channel selection mechanism may be configured to provide a technical solution to support the AP in selecting a working channel (“an operational channel”) for communication with one or more client STAs, for example, while taking into consideration channel conditions at locations of the client STAs, for example, the “client” noise and/or interference at a location of a client STA.

In some demonstrative aspects, an AP, e.g., the AP implemented by device 102, may receive measurement-based information from a plurality of client STAs, e.g., client STAs implemented by devices 140 and/or device 160, e.g., as described below.

In some demonstrative aspects, the AP, e.g., the AP implemented by device 102, may be configured to determine the selected channel to be used by the AP, for example, based on the measurement-based information from the plurality of client STAs, e.g., as described below.

In some demonstrative aspects, the measurement-based information from a client STA may be based on measurements performed by the client STA. Accordingly, the measurement-based information from the client STA may represent a client-specific channel preference corresponding to the client STA.

For example, measurement-based information from a client STA implemented by device 140 may be based on measurements performed with respect to a location of device 140. For example, the measurement-based information from the client STA implemented by device 140 may represent a client-specific channel preference corresponding to the client STA implemented by device 140. For example, the measurement-based information from a client STA implemented by device 140 may indicate that a first channel should be preferred for communication with the client STA implemented by device 140.

For example, measurement-based information from a client STA implemented by device 160 may be based on measurements performed with respect to a location of device 160. For example, the measurement-based information from the client STA implemented by device 160 may represent a client-specific channel preference corresponding to the client STA implemented by device 160. For example, the measurement-based information from a client STA implemented by device 160 may indicate that a second channel, e.g., different from the first channel, should be preferred for communication with the client STA implemented by device 160.

In some demonstrative aspects, the AP, e.g., the AP implemented by device 102, may be configured to determine the selected channel to be used by the AP, for example, based on a plurality of client-specific channel preferences corresponding to the plurality of client STAs, e.g., as described below.

In some demonstrative aspects, the AP, e.g., the AP implemented by device 102, may be configured to determine the plurality of client-specific channel preferences corresponding to the plurality of client STAs, for example, based on the measurement-based information from a plurality of client STAs, e.g., as described below.

In some demonstrative aspects, the AP, e.g., the AP implemented by device 102, may be configured to determine the selected channel to be used by the AP, for example, based on a selection criterion, which may be applied to the measurement-based information from a plurality of client STAs, e.g., for the entire network.

In some demonstrative aspects, the selection criterion may be configured to select a channel, which is best preferred, e.g., for the entire network, as described below.

In some demonstrative aspects, the AP, e.g., the AP implemented by device 102, may be configured to utilize a radio measurement element as a mechanism to retrieve the measurement-based information from the client STAs, e.g., as described below.

For example, the AP may be configured to use measurement-based information in a radio measurement element, for example, for frequency selection, e.g., in addition to and/or instead of using the measurement-based information for an AP advertised measurement report.

In some demonstrative aspects, controller 124 may be configured to control, trigger, cause, and/or instruct an AP implemented by device 102 to transmit measurement requests to a plurality of STAs in a Basic Service Set (BSS) of the AP, e.g., as described below.

For example, the AP implemented by device 102 may transmit the measurement requests to a plurality of STAs, e.g., including STAs implemented by device 140 and/or device 160, in the BSS of the AP.

In some demonstrative aspects, controller 124 may be configured to control, trigger, cause, and/or instruct the AP implemented by device 102 to process measurement reports from the plurality of STAs in the BSS, e.g., as described below.

In some demonstrative aspects, a measurement report from a STA of the plurality of STAs in the BSS may include reported measurements of the STA with respect to one or more wireless communication channels, e.g., as described below.

In some demonstrative aspects, controller 124 may be configured to control, trigger, cause, and/or instruct the AP implemented by device 102 to determine a selected wireless communication channel for the BSS, for example, based on the measurement reports from the plurality of STAs in the BSS, e.g., as described below.

In some demonstrative aspects, controller 124 may be configured to control, trigger, cause, and/or instruct the AP implemented by device 102 to trigger a channel switch, for example, to switch an operational channel of the BSS to the selected wireless communication channel, e.g., as described below.

In some demonstrative aspects, controller 124 may be configured to control, trigger, cause, and/or instruct the AP implemented by device 102 to trigger the channel switch, for example, by triggering a Dynamic Frequency Selection (DFS), for example, in accordance with an IEEE 802.11 Specification, e.g., as described below.

In other aspects, the channel switch may be implemented according to any other additional or alternative channel switching mechanism and/or technique.

In some demonstrative aspects, controller 124 may be configured to control, trigger, cause, and/or instruct the AP implemented by device 102 to transmit the measurement requests and to receive the measurement reports from the plurality of STAs over the operational channel of the BSS, e.g., as described below.

In some demonstrative aspects, controller 124 may be configured to control, trigger, cause, and/or instruct the AP implemented by device 102 to set the operational channel of the BSS to a first wireless communication channel, e.g., as described below.

In some demonstrative aspects, controller 124 may be configured to control, trigger, cause, and/or instruct the AP implemented by device 102 to transmit the measurement requests and to receive the measurement reports from the plurality of STAs over the first wireless communication channel, e.g., as described below.

In some demonstrative aspects, controller 124 may be configured to control, trigger, cause, and/or instruct the AP implemented by device 102 to determine a second wireless communication channel, for example, based on the measurement reports from the plurality of STAs, e.g., as described below.

In some demonstrative aspects, controller 124 may be configured to control, trigger, cause, and/or instruct the AP implemented by device 102 to trigger the channel switch to switch the operational channel of the BSS to the second wireless communication channel, e.g., as described below.

In some demonstrative aspects, controller 124 may be configured to control, trigger, cause, and/or instruct the AP implemented by device 102 to determine the selected wireless communication channel for the BSS, for example, based on a predefined selection function applied to the measurement reports from the plurality of STAs in the BSS, e.g., as described below.

In some demonstrative aspects, the selection function may be configured to provide a score to a particular wireless communication channel, for example, based on reported measurements which correspond to the particular wireless communication channel in the measurement reports from the plurality of STAs in the BSS, e.g., as described below.

In some demonstrative aspects, controller 124 may be configured to control, trigger, cause, and/or instruct the AP implemented by device 102 to determine a plurality of STA-specific channel preferences for the plurality of STAs, for example, based on the measurement reports from the plurality of STAs in the BSS, e.g., as described below.

In some demonstrative aspects, a STA-specific channel preference for a STA may be configured to include one or more preferred wireless communication channels for the STA, for example, based on the measurement report from the STA, e.g., as described below.

In some demonstrative aspects, the one or more preferred wireless communication channels for the STA may include a predefined count of wireless communication channels having best reported measurements in the measurement report from the STA, e.g., as described below.

In other aspects, the one or more preferred wireless communication channels for the STA may be defied according to any other additional or alternative criteria.

In some demonstrative aspects, controller 124 may be configured to control, trigger, cause, and/or instruct the AP implemented by device 102 to determine the selected wireless communication channel for the BSS, for example, based on the plurality of STA-specific channel preferences, e.g., as described below.

In some demonstrative aspects, the measurement reports from the plurality of STAs in the BSS may include a plurality of channel load reports from the plurality of STAs, e.g., as described below.

In some demonstrative aspects, a measurement report from a STA may include a channel load report from the STA, e.g., as described below.

In some demonstrative aspects, the channel load report from the STA may include one or more channel load values corresponding to the one or more wireless communication channels, respectively, e.g., as described below.

In other aspects, the measurement reports from the plurality of STAs in the BSS may include reports relating to any other additional or alternative parameter corresponding to the one or more wireless communication channels. In one example, the measurement reports from the plurality of STAs in the BSS may include noise histogram information, STA statistics, and/or any other type of information.

For example, controller 124 may be configured to control, trigger, cause, and/or instruct the AP implemented by device 102 to determine the selected wireless communication channel for the BSS, for example, based on any other additional or alternative information in the measurement reports from the plurality of STAs, e.g., the noise histogram information, STA statistics, and/or any other type of information.

In some demonstrative aspects, controller 124 may be configured to control, trigger, cause, and/or instruct the AP implemented by device 102 to determine a plurality of channel load scores corresponding to a respective plurality of wireless communication channels, for example, based on the plurality of channel load reports, e.g., as described below.

In some demonstrative aspects, a channel load score for a particular wireless communication channel may be based, for example, on channel load values corresponding to the particular wireless communication channel in the plurality of channel load reports, e.g., as described below.

In some demonstrative aspects, controller 124 may be configured to control, trigger, cause, and/or instruct the AP implemented by device 102 to determine the selected wireless communication channel for the BSS, for example, based on the plurality of channel load scores, e.g., as described below.

In some demonstrative aspects, controller 124 may be configured to control, trigger, cause, and/or instruct the AP implemented by device 102 to determine the channel load score for the particular wireless communication channel, for example, based on an extremum channel load value corresponding to the particular wireless communication channel in the plurality of channel load reports, e.g., as described below.

In some demonstrative aspects, controller 124 may be configured to control, trigger, cause, and/or instruct the AP implemented by device 102 to determine the channel load score for the particular wireless communication channel, for example, based on a predefined aggregation function applied to channel load values corresponding to the particular wireless communication channel in the plurality of channel load reports, e.g., as described below.

In other aspects, controller 124 may be configured to control, trigger, cause, and/or instruct the AP implemented by device 102 to determine the channel load score for the particular wireless communication channel, for example, based on any other additional or alternative criteria and/or function.

In some demonstrative aspects, controller 124 may be configured to control, trigger, cause, and/or instruct the AP implemented by device 102 to determine the selected wireless communication channel for the BSS, for example, based on a predefined selection function applied to the plurality of channel load reports, e.g., as described below.

In some demonstrative aspects, the predefined selection function may be configured to provide a score to a particular wireless communication channel, for example, based on a combination of the channel load values which correspond to the particular wireless communication channel in the plurality of channel load reports, e.g., as described below.

In other aspects, the predefined selection function may be configured to provide the score to a particular wireless communication channel, for example, based on any other additional or alternative criteria and/or function.

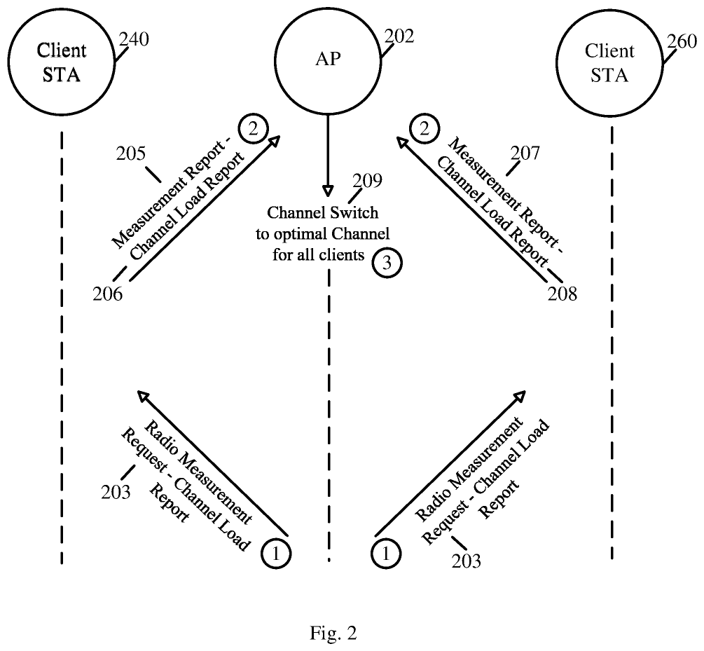

Reference is made to FIG. 2, which schematically illustrates communications between an AP and client STAs according to a channel selection mechanism, in accordance with some demonstrative aspects.

In some demonstrative aspects, an AP 202, a client STA 240, and/or a client STA 260 may be configured to implement the channel selection mechanism to coordinate a selection, e.g., a client driven selection, of a wireless communication channel to communicate on, e.g., as described below.

For example, device 102 (FIG. 1) may perform one or more operations, one or more functionalities, the role of, and/or the functionality of, AP 202.

For example, device 140 (FIG. 1) may perform one or more operations, one or more functionalities, the role of, and/or the functionality of, client STA 240.

For example, device 160 (FIG. 1) may perform one or more operations, one or more functionalities, the role of, and/or the functionality of, client STA 260.

In some demonstrative aspects, as shown in FIG. 2, AP 202 may be configured to transmit measurement requests 203 to client STA 240 and/or client STA 260, which may be in a BSS of AP 202.

In some demonstrative aspects, as shown in FIG. 2, measurement request 203 may include a request for a channel load report. In other aspects, measurement request 203 may include a request for any other additional or alternative type of measurement-based information.

In some demonstrative aspects, as shown in FIG. 2, AP 202 may be configured to process a measurement report 205 from client STA 240. For example, measurement report 205 may include reported measurements of client STA 240 with respect to one or more wireless communication channels.

In some demonstrative aspects, the measurement report 205 from client STA 240 may include a channel load report 206 from client STA 240. For example, channel load report 206 may include one or more channel load values corresponding to the one or more wireless communication channels, respectively, e.g., as measured by client STA 240.

In some demonstrative aspects, as shown in FIG. 2, AP 202 may be configured to process a measurement report 207 from client STA 260. For example, measurement report 207 may include reported measurements of client STA 260 with respect to the one or more wireless communication channels.

In some demonstrative aspects, measurement report 207 from client STA 260 may include a channel load report 208 from client STA 260. For example, channel load report 208 may include one or more channel load values corresponding to the one or more wireless communication channels, respectively, e.g., as measured by client STA 260.

In some demonstrative aspects, AP 202 may be configured to transmit the measurement requests 203, and to receive the measurement report 205 and/or measurement report 207 over an operational channel of the BSS of AP 202.

In some demonstrative aspects, AP 202 may be configured to determine a selected wireless communication channel for the BSS, for example, based on measurement report 205 and/or measurement report 207.

In some demonstrative aspects, as shown in FIG. 2, AP 202 may be configured to trigger a channel switch 209 to switch the operational channel of the BSS to the selected wireless communication channel.

In some demonstrative aspects, the selected wireless communication channel may be determined to include, for example, a channel, which may be identified as the best preferred channel for communication between AP 202 and client STA 240 and/or client STA 260, e.g., as described below.

In some demonstrative aspects, it may be defined that AP 202 is to select the selected wireless communication channel according to the result of a predefined selection function, e.g., a cost function, that is calculated, for example, based on the measurement reports received from all STAs in the BSS of AP 202, e.g., as described below.

For example, AP 202 may determine the selected wireless communication channel, for example, based on the measurement report 205 from client STA 240, and/or the measurement report 207 from client STA 260.

In some demonstrative aspects, AP 202 may be configured to determine the selected wireless communication channel, for example, based on a selection function, which is applied to aggregated channel load values, e.g., as described below.

In some demonstrative aspects, AP 202 may transmit the measurement request 203 in the form of a radio measurement request, e.g., in accordance with an IEEE 802.11 Specification.

In some demonstrative aspects, it may be defined that a client STA, e.g., each STA in the BSS, is to send a channel load report including a channel measurement, e.g., in the form of a channel load value. For example, the channel load value may be calculated, e.g., as follows:

$$Channel Load = [ \frac{channel busy time}{MeasurementDuration \times 1024} \times 225 ] \qquad ( 1 )$$

In other aspects, the channel load value may be defined according to any other calculation.

For example, AP 202 may process channel load report 206, which may include one or more channel load values corresponding to one or more wireless communication channels as determined by the client STA 240, e.g., according to Equation 1; and/or channel load report 208, which may include one or more channel load values corresponding to one or more wireless communication channels as determined by the client STA 260, e.g., according to Equation 1.

In some demonstrative aspects, it may be defined that, after receiving channel load reports from the plurality of STAs, e.g., the client STA 240 and/or client STA 260, the AP 202 is to aggregate one or more channel load reports, e.g., all reports, per channel, for example, by using the one or more channel load values to determine an aggregated channel load value, e.g., as follows:

Channel=max(ChannelLoad) (2)

In some demonstrative aspects, it may be defined that AP 202 is to determine the selected wireless communication channel for the BSS of AP 202, for example, to include a channel, which may be identified, e.g., from all channels, as an “optimal” channel for all client STAs, e.g., as follows:

Channel=f(Σ_{All channels} min(channelLoad)) (3)

In some demonstrative aspects, it may be defined that AP 202 is to use a channel switch operation, e.g., channel switch 209, to switch to a new channel, e.g., the selected channel.

For example, AP 202 may use channel switch 209 to switch the operational channel of the BSS of AP 202 to the selected wireless communication channel.

In some demonstrative aspects, AP 202 may be configured to determine the selected wireless communication channel, for example, based on a selection function, which is applied to STA-specific channel preferences, e.g., as described below.

In some demonstrative aspects, it may be defined that, after receiving channel load reports from the plurality of STAs, e.g., client STA 240 and/or client STA 260, AP 202 is to sort the channels, for example, according to channel load value (number).

For example, AP 202 may sort the channels, for example, according to channel load value (number), e.g., in descending order per STA.

In some demonstrative aspects, it may be defined that AP 202 is to select the wireless communication channel which the majority of STAs agree on, for example, by identifying which channel corresponds to a best combination of the channel load numbers from all client STAs.

In some demonstrative aspects, it may be defined that AP 202 is to use a channel switch operation, e.g., channel switch 209, to move to a new channel, e.g., the selected channel.

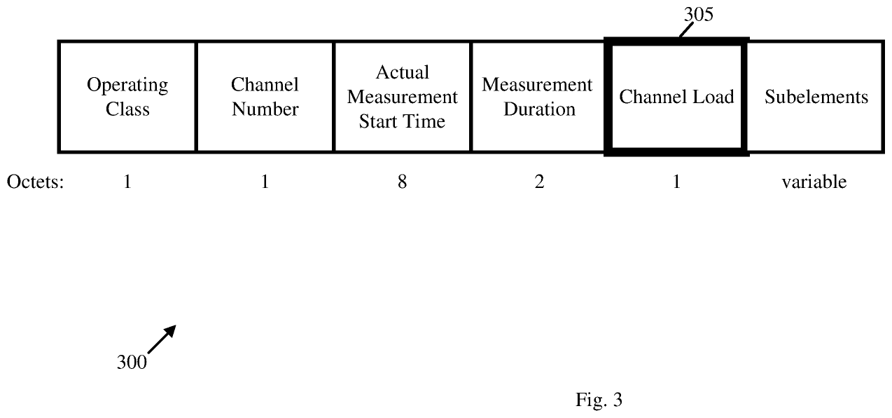

Reference is made to FIG. 3, which schematically illustrates a measurement report field 300, which may be implemented in accordance with some demonstrative aspects.

For example, measurement report 205 (FIG. 2) and/or measurement report 207 (FIG. 2) may include measurement report field 300.

In some demonstrative aspects, AP 202 (FIG. 2), client STA 240 (FIG. 2), and/or client STA 260 (FIG. 2) may be configured to communicate measurement reports according to the format of measurement report field 300.

In some demonstrative aspects, measurement report field 300 may include reported measurements of a STA (reporting STA) transmitting the measurement report field 300, e.g., client STA 240 (FIG. 2) and/or client STA 260 (FIG. 2).

In some demonstrative aspects, measurement report field 300 may include reported measurements of the reporting STA with respect to one or more wireless communication channels.

In some demonstrative aspects, as shown in FIG. 3, measurement report field 300 may include one or more channel load values 305 corresponding to the one or more wireless communication channels, respectively.

In one example, AP 202 (FIG. 2) may determine a selected wireless communication channel, for example, based on channel load values 305 in measurement report field 300, e.g., in measurement reports received from a plurality of client STAs.

In another example, AP 202 (FIG. 2) may determine the selected wireless communication channel, for example, based on any other additional or alternative information in measurement report field 300.

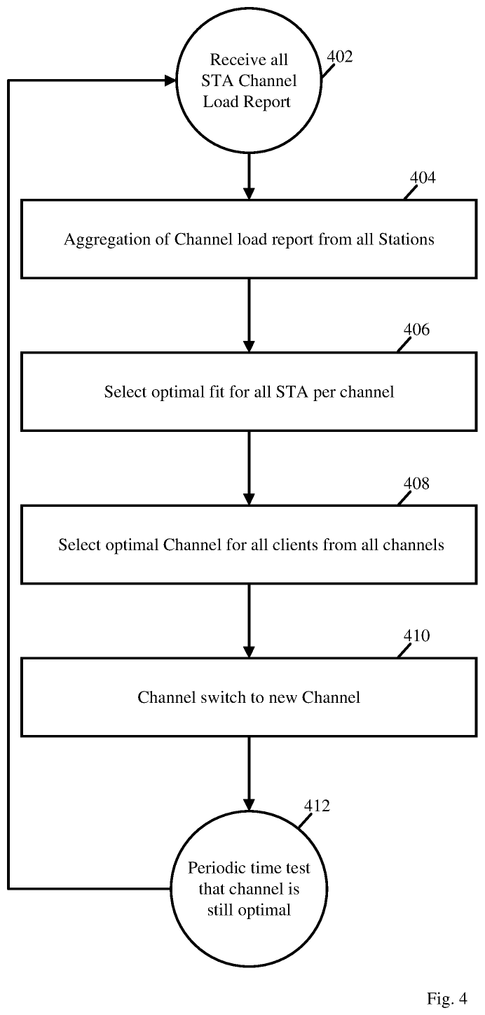

Reference is made to FIG. 4, which schematically illustrates a method of switching a wireless communication channel, in accordance with some demonstrative aspects. For example, one or more of the operations of the method of FIG. 4 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 402, the method may include receiving at an AP channel load reports from a plurality of STAs, e.g., some or all STAs, in a BSS of the AP. For example, controller 124 (FIG. 1) may be configured to cause, trigger, and/or control device 102 (FIG. 1) to receive channel load reports from some or all STAs in a BSS of device 102 (FIG. 1), e.g., as described above.

As indicated at block 404, the method may include aggregating the channel load reports from the STAs. For example, controller 124 (FIG. 1) may be configured to cause, trigger, and/or control device 102 (FIG. 1) to aggregate the channel load reports from the STAs, e.g., as described above.

As indicated at block 406, the method may include determining a plurality of STA-specific channel preferences for the plurality of STAs. For example, controller 124 (FIG. 1) may be configured to cause, trigger, and/or control device 102 (FIG. 1) to select an optimal fit for all STAs per channel, e.g., as described above.

As indicated at block 408, the method may include selecting a channel for all STAs from all channels, for example, based on the STA-specific channel preferences. For example, controller 124 (FIG. 1) may be configured to cause, trigger, and/or control device 102 (FIG. 1) to select an optimal channel for all STAs from all channels, for example, based on the optimal fit for all STAs per channel, e.g., as described above.

As indicated at block 410, the method may include switching the BSS to the selected channel. For example, controller 124 (FIG. 1) may be configured to cause, trigger, and/or control device 102 (FIG. 1) to switch a channel of the BSS to the optimal channel, e.g., as described above.

As indicated at block 412, the method may include periodically repeating the operations of the method of FIG. 4. For example, controller 124 (FIG. 1) may be configured to cause, trigger, and/or control device 102 (FIG. 1) to repeat operations of the method of FIG. 4, for example, to periodically test that a current channel of the BSS is still the optimal channel, e.g., as described above.

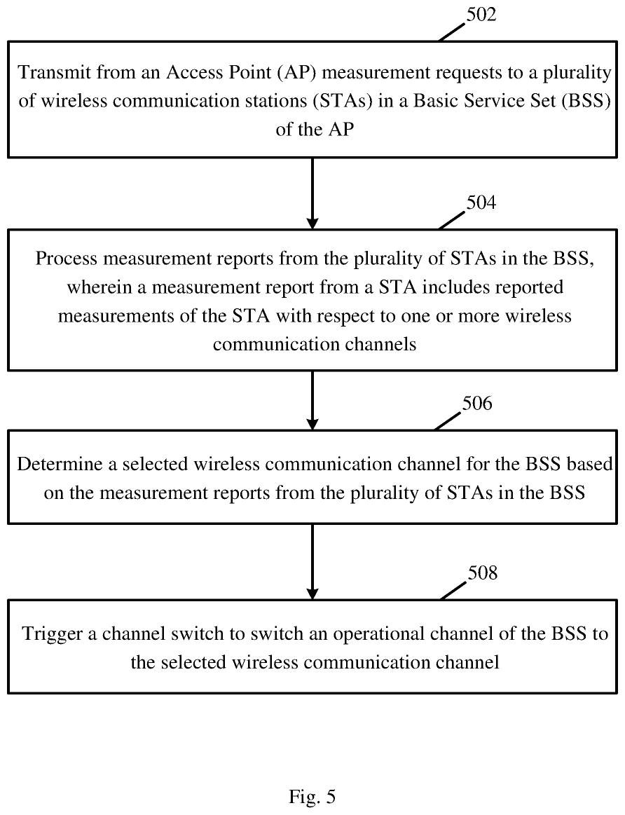

Reference is made to FIG. 5, which schematically illustrates a method of switching a wireless communication channel, in accordance with some demonstrative aspects. For example, one or more of the operations of the method of FIG. 5 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 502, the method may include transmitting from an AP measurement requests to a plurality of STAs in a BSS of the AP. For example, controller 124 (FIG. 1) may be configured to cause, trigger, and/or control device 102 (FIG. 1) to transmit measurement requests to device 140 (FIG. 1) and/or device 160 (FIG. 1) in a BSS of device 102 (FIG. 1), e.g., as described above.

As indicated at block 504, the method may include processing measurement reports from the plurality of STAs in the BSS. For example, a measurement report from a STA may include reported measurements of the STA with respect to one or more wireless communication channels. For example, controller 124 (FIG. 1) may be configured to cause, trigger, and/or control device 102 (FIG. 1) to process measurement reports from device 140 (FIG. 1) and/or device 160 (FIG. 1), e.g., as described above.

As indicated at block 506, the method may include determining a selected wireless communication channel for the BSS based, for example, on the measurement reports from the plurality of STAs in the BSS. For example, controller 124 (FIG. 1) may be configured to cause, trigger, and/or control device 102 (FIG. 1) to determine a selected wireless communication channel for the BSS based on the measurement reports from device 140 (FIG. 1) and/or device 160 (FIG. 1), e.g., as described above.

As indicated at block 506, the method may include triggering a channel switch to switch an operational channel of the BSS to the selected wireless communication channel. For example, controller 124 (FIG. 1) may be configured to cause, trigger, and/or control device 102 (FIG. 1) to trigger a channel switch to switch an operational channel of the BSS to the selected wireless communication channel, e.g., as described above.

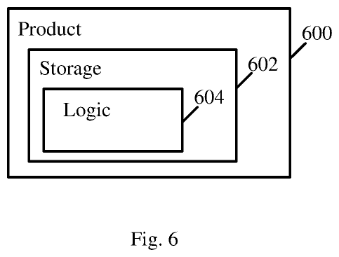

Reference is made to FIG. 6, which schematically illustrates a product of manufacture 600, in accordance with some demonstrative aspects. Product 600 may include one or more tangible computer-readable (“machine-readable”) non-transitory storage media 602, which may include computer-executable instructions, e.g., implemented by logic 604, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1-5, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 600 and/or machine readable storage media 1002 may include one or more types of computer-readable storage media capable of storing data, including volatile memory, non-volatile memory, removable or non-removable memory, erasable or non-erasable memory, writeable or re-writeable memory, and the like. For example, machine readable storage media 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a hard drive, an optical disk, a magnetic disk, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### Examples

The following examples pertain to further aspects.

Example 1 includes an apparatus comprising logic and circuitry configured to cause an Access Point (AP) to transmit measurement requests to a plurality of wireless communication stations (STAs) in a Basic Service Set (BSS) of the AP; process measurement reports from the plurality of STAs in the BSS, wherein a measurement report from a STA comprises reported measurements of the STA with respect to one or more wireless communication channels; determine a selected wireless communication channel for the BSS based on the measurement reports from the plurality of STAs in the BSS; and trigger a channel switch to switch an operational channel of the BSS to the selected wireless communication channel.

Example 2 includes the subject matter of Example 1, and optionally, wherein the measurement reports from the plurality of STAs in the BSS comprise a plurality of channel load reports from the plurality of STAs, wherein the measurement report from the STA comprises a channel load report from the STA comprising one or more channel load values corresponding to the one or more wireless communication channels, respectively.

Example 3 includes the subject matter of Example 2, and optionally, wherein the apparatus is configured to cause the AP to determine a plurality of channel load scores corresponding to a respective plurality of wireless communication channels based on the plurality of channel load reports, wherein a channel load score for a particular wireless communication channel is based on channel load values corresponding to the particular wireless communication channel in the plurality of channel load reports; and determine the selected wireless communication channel for the BSS based on the plurality of channel load scores.

Example 4 includes the subject matter of Example 3, and optionally, wherein the apparatus is configured to cause the AP to determine the channel load score for the particular wireless communication channel based on an extremum channel load value corresponding to the particular wireless communication channel in the plurality of channel load reports.

Example 5 includes the subject matter of Example 3, and optionally, wherein the apparatus is configured to cause the AP to determine the channel load score for the particular wireless communication channel based on a predefined aggregation function applied to channel load values corresponding to the particular wireless communication channel in the plurality of channel load reports.

Example 6 includes the subject matter of any one of Examples 2-5, and optionally, wherein the apparatus is configured to cause the AP to determine the selected wireless communication channel for the BSS based on a predefined selection function applied to the plurality of channel load reports, wherein the predefined selection function is to provide a score to a particular wireless communication channel based on a combination of the channel load values which correspond to the particular wireless communication channel in the plurality of channel load reports.

Example 7 includes the subject matter of any one of Examples 1-6, and optionally, wherein the apparatus is configured to cause the AP to determine a plurality of STA-specific channel preferences for the plurality of STAs based on the measurement reports from the plurality of STAs in the BSS, wherein a STA-specific channel preference for the STA comprises one or more preferred wireless communication channels for the STA based on the measurement report from the STA; and determine the selected wireless communication channel for the BSS based on the plurality of STA-specific channel preferences.

Example 8 includes the subject matter of Example 7, and optionally, wherein the one or more preferred wireless communication channels for the STA comprises a predefined count of wireless communication channels having best reported measurements in the measurement report from the STA.

Example 9 includes the subject matter of any one of Examples 1-8, and optionally, wherein the apparatus is configured to cause the AP to determine the selected wireless communication channel for the BSS based on a predefined selection function applied to the measurement reports from the plurality of STAs in the BSS, wherein the selection function is to provide a score to a particular wireless communication channel based on reported measurements which correspond to the particular wireless communication channel in the measurement reports from the plurality of STAs in the BSS.

Example 10 includes the subject matter of any one of Examples 1-9, and optionally, wherein the apparatus is configured to cause the AP to set the operational channel of the BSS to a first wireless communication channel, to transmit the measurement requests and to receive the measurement reports from the plurality of STAs over the first wireless communication channel, to determine a second wireless communication channel based on the measurement reports from the plurality of STAs, and to trigger the channel switch to switch the operational channel of the BSS to the second wireless communication channel.

Example 11 includes the subject matter of any one of Examples 1-10, and optionally, wherein the apparatus is configured to cause the AP to transmit the measurement requests and to receive the measurement reports from the plurality of STAs over the operational channel of the BSS.

Example 12 includes the subject matter of any one of Examples 1-11, and optionally, wherein the apparatus is configured to cause the AP to trigger the channel switch by triggering a Dynamic Frequency Selection (DFS).

Example 13 includes the subject matter of any one of Examples 1-12, and optionally, comprising at least one radio to transmit the measurement requests and to receive the measurement reports.

Example 14 includes the subject matter of Example 13, and optionally, comprising one or more antennas connected to the radio, and a processor to execute instructions of an operating system of the AP.

Example 15 comprises a wireless communication device comprising the apparatus of any of Examples 1-14.

Example 16 comprises an apparatus comprising means for executing any of the described operations of any of Examples 1-14.

Example 17 comprises a product comprising one or more tangible computer-readable non-transitory storage media comprising instructions operable to, when executed by at least one processor, enable the at least one processor to cause a wireless communication device to perform any of the described operations of any of Examples 1-14.

Example 18 comprises an apparatus comprising: a memory interface; and processing circuitry configured to: perform any of the described operations of any of Examples 1-14.

Example 19 comprises a method comprising any of the described operations of any of Examples 1-14.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause an Access Point (AP) to:
transmit measurement requests to a plurality of wireless communication stations (STAs) in a Basic Service Set (BSS) of the AP;
process measurement reports from the plurality of STAs in the BSS, wherein a measurement report from a STA comprises reported measurements of the STA with respect to one or more wireless communication channels;
determine a selected wireless communication channel for the BSS based on the measurement reports from the plurality of STAs in the BSS; and
trigger a channel switch to switch an operational channel of the BSS to the selected wireless communication channel.

2. The apparatus of claim 1, wherein the measurement reports from the plurality of STAs in the BSS comprise a plurality of channel load reports from the plurality of STAs, wherein the measurement report from the STA comprises a channel load report from the STA comprising one or more channel load values corresponding to the one or more wireless communication channels, respectively.

3. The apparatus of claim 2 configured to cause the AP to:
determine a plurality of channel load scores corresponding to a respective plurality of wireless communication channels based on the plurality of channel load reports, wherein a channel load score for a particular wireless communication channel is based on channel load values corresponding to the particular wireless communication channel in the plurality of channel load reports; and
determine the selected wireless communication channel for the BSS based on the plurality of channel load scores.

4. The apparatus of claim 3 configured to cause the AP to determine the channel load score for the particular wireless communication channel based on an extremum channel load value corresponding to the particular wireless communication channel in the plurality of channel load reports.

5. The apparatus of claim 3 configured to cause the AP to determine the channel load score for the particular wireless communication channel based on a predefined aggregation function applied to channel load values corresponding to the particular wireless communication channel in the plurality of channel load reports.

6. The apparatus of claim 2 configured to cause the AP to determine the selected wireless communication channel for the BSS based on a predefined selection function applied to the plurality of channel load reports, wherein the predefined selection function is to provide a score to a particular wireless communication channel based on a combination of the channel load values which correspond to the particular wireless communication channel in the plurality of channel load reports.

7. The apparatus of claim 1 configured to cause the AP to:
determine a plurality of STA-specific channel preferences for the plurality of STAs based on the measurement reports from the plurality of STAs in the BSS, wherein a STA-specific channel preference for the STA comprises one or more preferred wireless communication channels for the STA based on the measurement report from the STA; and
determine the selected wireless communication channel for the BSS based on the plurality of STA-specific channel preferences.

8. The apparatus of claim 7, wherein the one or more preferred wireless communication channels for the STA comprises a predefined count of wireless communication channels having best reported measurements in the measurement report from the STA.

9. The apparatus of claim 1 configured to cause the AP to determine the selected wireless communication channel for the BSS based on a predefined selection function applied to the measurement reports from the plurality of STAs in the BSS, wherein the selection function is to provide a score to a particular wireless communication channel based on reported measurements which correspond to the particular wireless communication channel in the measurement reports from the plurality of STAs in the BSS.

10. The apparatus of claim 1 configured to cause the AP to set the operational channel of the BSS to a first wireless communication channel, to transmit the measurement requests and to receive the measurement reports from the plurality of STAs over the first wireless communication channel, to determine a second wireless communication channel based on the measurement reports from the plurality of STAs, and to trigger the channel switch to switch the operational channel of the BSS to the second wireless communication channel.

11. The apparatus of claim 1 configured to cause the AP to transmit the measurement requests and to receive the measurement reports from the plurality of STAs over the operational channel of the BSS.

12. The apparatus of claim 1 configured to cause the AP to trigger the channel switch by triggering a Dynamic Frequency Selection (DFS).

13. The apparatus of claim 1 comprising at least one radio to transmit the measurement requests and to receive the measurement reports.

14. The apparatus of claim 13 comprising one or more antennas connected to the radio, and a processor to execute instructions of an operating system of the AP.

15. A product comprising one or more tangible computer-readable non-transitory storage media comprising instructions operable to, when executed by at least one processor, enable the at least one processor to cause an Access Point (AP) to:
transmit measurement requests to a plurality of wireless communication stations (STAs) in a Basic Service Set (BSS) of the AP;
process measurement reports from the plurality of STAs in the BSS, wherein a measurement report from a STA comprises reported measurements of the STA with respect to one or more wireless communication channels;
determine a selected wireless communication channel for the BSS based on the measurement reports from the plurality of STAs in the BSS; and
trigger a channel switch to switch an operational channel of the BSS to the selected wireless communication channel.

16. The product of claim 15, wherein the measurement reports from the plurality of STAs in the BSS comprise a plurality of channel load reports from the plurality of STAs, wherein the measurement report from the STA comprises a channel load report from the STA comprising one or more channel load values corresponding to the one or more wireless communication channels, respectively.

17. The product of claim 16, wherein the instructions, when executed, cause the AP to:
determine a plurality of channel load scores corresponding to a respective plurality of wireless communication channels based on the plurality of channel load reports, wherein a channel load score for a particular wireless communication channel is based on channel load values corresponding to the particular wireless communication channel in the plurality of channel load reports; and
determine the selected wireless communication channel for the BSS based on the plurality of channel load scores.

18. The product of claim 17, wherein the instructions, when executed, cause the AP to determine the channel load score for the particular wireless communication channel based on an extremum channel load value corresponding to the particular wireless communication channel in the plurality of channel load reports.

19. The product of claim 17, wherein the instructions, when executed, cause the AP to determine the channel load score for the particular wireless communication channel based on a predefined aggregation function applied to channel load values corresponding to the particular wireless communication channel in the plurality of channel load reports.

20. The product of claim 16, wherein the instructions, when executed, cause the AP to determine the selected wireless communication channel for the BSS based on a predefined selection function applied to the plurality of channel load reports, wherein the predefined selection function is to provide a score to a particular wireless communication channel based on a combination of the channel load values which correspond to the particular wireless communication channel in the plurality of channel load reports.

21. The product of claim 15, wherein the instructions, when executed, cause the AP to:
determine a plurality of STA-specific channel preferences for the plurality of STAs based on the measurement reports from the plurality of STAs in the BSS, wherein a STA-specific channel preference for the STA comprises one or more preferred wireless communication channels for the STA based on the measurement report from the STA; and
determine the selected wireless communication channel for the BSS based on the plurality of STA-specific channel preferences.

22. The product of claim 15, wherein the instructions, when executed, cause the AP to determine the selected wireless communication channel for the BSS based on a predefined selection function applied to the measurement reports from the plurality of STAs in the BSS, wherein the selection function is to provide a score to a particular wireless communication channel based on reported measurements which correspond to the particular wireless communication channel in the measurement reports from the plurality of STAs in the BSS.

23. The product of claim 15, wherein the instructions, when executed, cause the AP to set the operational channel of the BSS to a first wireless communication channel, to transmit the measurement requests and to receive the measurement reports from the plurality of STAs over the first wireless communication channel, to determine a second wireless communication channel based on the measurement reports from the plurality of STAs, and to trigger the channel switch to switch the operational channel of the BSS to the second wireless communication channel.

24. An apparatus for an Access Point (AP), the apparatus comprising:
means for causing the AP to transmit measurement requests to a plurality of wireless communication stations (STAs) in a Basic Service Set (BSS) of the AP;
means for processing measurement reports from the plurality of STAs in the BSS, wherein a measurement report from a STA comprises reported measurements of the STA with respect to one or more wireless communication channels;
means for determining a selected wireless communication channel for the BSS based on the measurement reports from the plurality of STAs in the BSS; and
means for triggering a channel switch to switch an operational channel of the BSS to the selected wireless communication channel.

25. The apparatus of claim 24 comprising means for determining the selected wireless communication channel for the BSS based on a predefined selection function applied to the measurement reports from the plurality of STAs in the BSS, wherein the selection function is to provide a score to a particular wireless communication channel based on reported measurements which correspond to the particular wireless communication channel in the measurement reports from the plurality of STAs in the BSS.
